(19) United States
(12) Patent Application Publication
(10) Pub. No.: US 2026/0048784 A1
(43) Pub. Date: Feb. 19, 2026

(54) INLINE MASTER DRIVE UNITS

(71) Applicant: Fairfield Manufacturing Company, Inc., Lafayette, IN (US)

(72) Inventors: Patrick D. ELMORE, Zionsville, IN (US); Rajesh HAMBARDE, Pune (IN)

(21) Appl. No.: 18/802,343

(22) Filed: Aug. 13, 2024

(51) Int. Cl. B62D 5/04; B60K 7/00

(52) U.S. Cl. CPC B62D 5/0418; B60K 7/0007; B62D 5/0442; B60K 2007/0069

(57) ABSTRACT

Systems are disclosed for a master drive unit including a traction motor, a steering motor, and a planetary steering system, wherein the traction motor, steering motor, and planetary steering system are mounted inline. The planetary steering system is a speed reduction system for reducing an output speed from the steering motor, whilst at the same time increasing output torque.

### TECHNICAL FIELD

The present description relates generally to inline master drive units for traction and steering of vehicles.

### BACKGROUND AND SUMMARY

Master drive units in vehicles and other machines with self-propulsion systems, such as forklifts, platform drives, lawnmowers, gantry cranes, and the like, are vertical drives for propulsion and steering. Traditional master drive units may include a traction drive and a steering drive mounted in parallel on a main frame. For example, the traction drive and the steering drive may be side by side and above the main frame. In at least some traditional master drive units, a steering pinion and steering gear are also side by side and positioned in mesh below the main frame with the steering gear coupled to a speed reduction drop box from the steering motor. Such a parallel design is not space-efficient, thus reducing space for other systems of a vehicle and complicating a spatial configuration of the systems. Further, the main frame may be precision machined to accommodate the traction drive and the steering drive, thereby increasing manufacturing complexity and resource demand.

Embodiments are disclosed herein that solve at least some of the issues described above with an inline master drive unit comprising a traction motor, a steering motor, and a planetary steering system, wherein the traction motor, the steering motor, and the planetary steering system are mounted in series along a single stacking axis rather than in parallel along two or more parallel axes. In this way, the inline master drive unit may be more compact. For example, the inline master drive unit may demand less volume for installation in a vehicle and occupy a smaller footprint. Compactness of the inline master drive unit may increase space for other ancillary systems and enhance ergonomics. Further, the mounting frame may not demand provision for mounting the steering drive, thereby reducing (e.g., avoiding) precision machining and resource demand. An inline master drive unit in accordance with the present disclosure may be used for traction and steering in a variety of applications including forklifts, platform drives, lawnmowers, gantry cranes, etc.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic of a vehicle with a master drive unit of the present disclosure.

FIG. 2 shows a perspective view of a master drive unit.

FIGS. 3A, 3B, and 3C show cross section views of a master drive unit with a carrier output configuration.

FIGS. 4A, 4B, and 4C show cross section views of a master drive unit with a ring gear output configuration.

FIG. 5 shows a cross section view of a planetary steering system of the master drive unit with the carrier output configuration.

FIG. 6 shows a perspective view of the planetary steering system of FIG. 5.

FIG. 7 shows a cross section view of a planet gear of the planetary steering system of FIG. 5.

FIG. 8 shows the planet gear.

FIG. 9 shows a cross section view of a planetary steering system of the master drive unit with the ring gear output configuration.

FIG. 10 shows a second cross section view of the planetary steering system of FIG. 9.

FIG. 11 shows a cross section view of a planet gear of the planetary steering system of FIG. 9.

FIG. 12 shows the planet gear.

### DETAILED DESCRIPTION

The following description relates to systems for a master drive unit arranged inline such that a traction motor and a steering motor thereof are coaxial with a planetary steering system. In this way, the traction motor, the steering motor, and the planetary steering system may be arranged vertically in a single stack, rather than laterally alongside each other or in parallel, thereby reducing a footprint of the master drive unit.

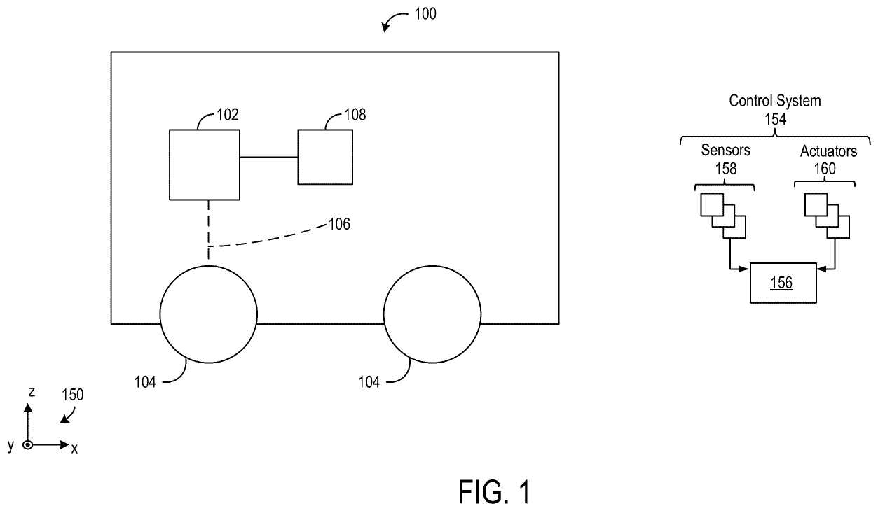

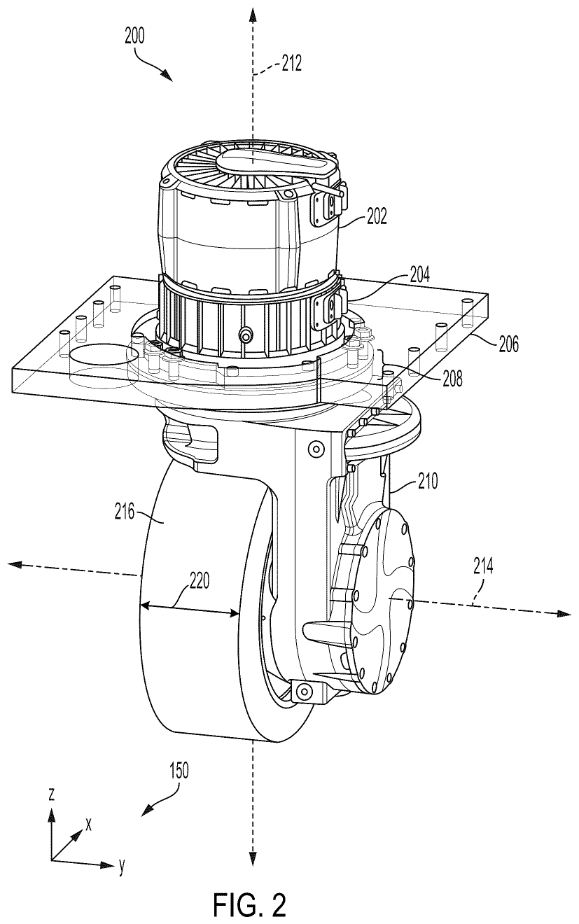

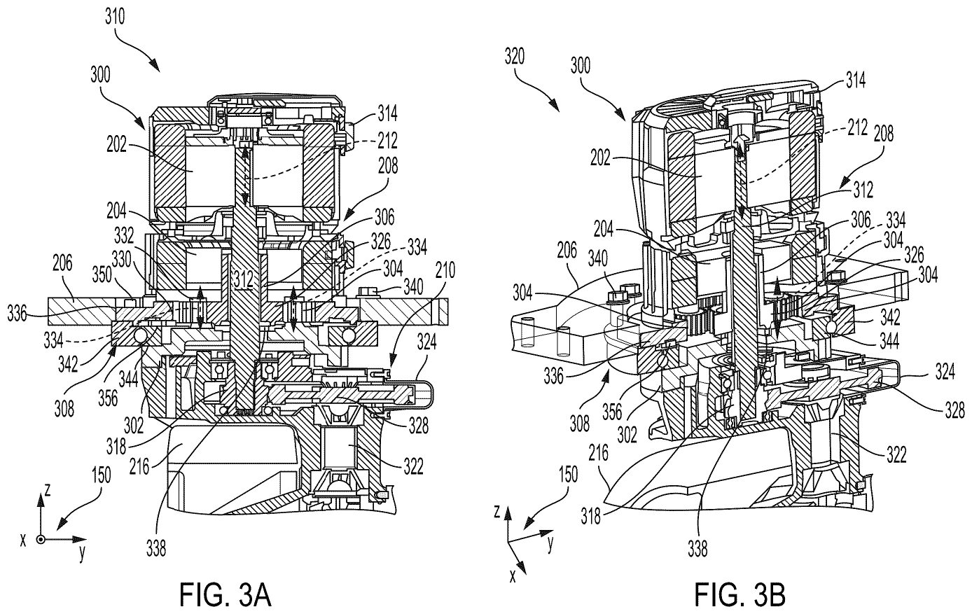

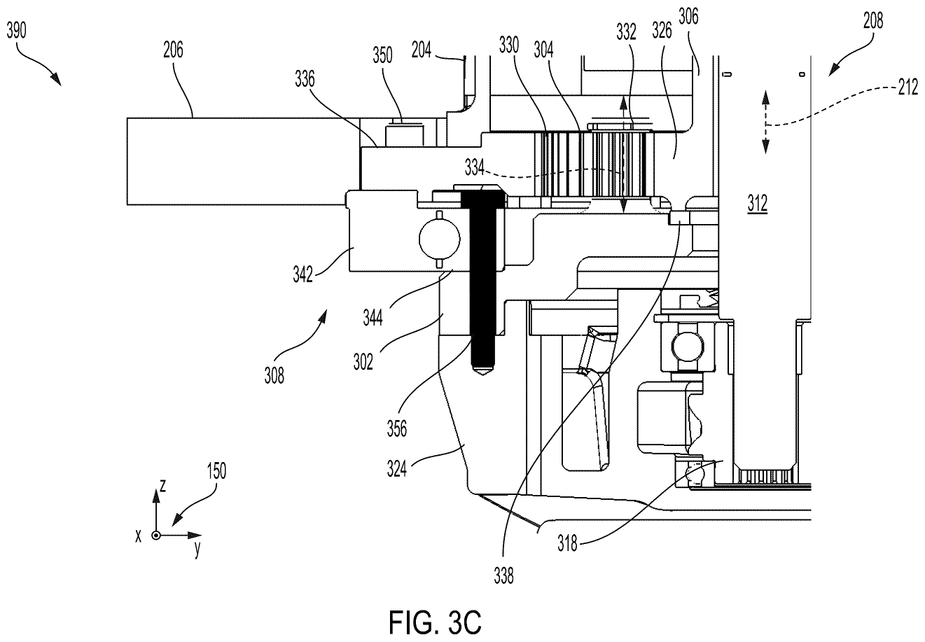

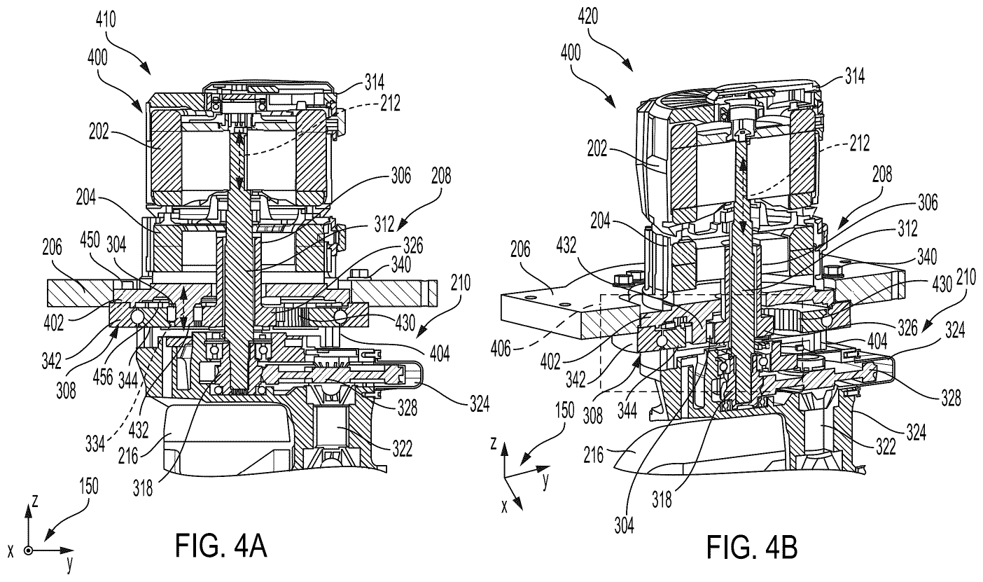

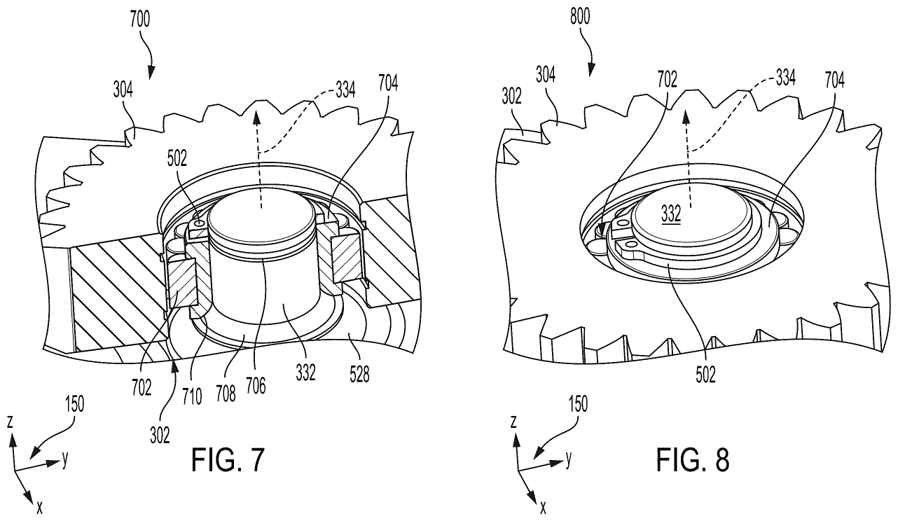

The master drive unit may be incorporated as a vertical drive unit in a vehicle, such as a forklift, for traction and steering. An example of such a vehicle is shown schematically in FIG. 1. An example of a master drive unit in accordance with the present disclosure is shown in FIG. 2. As described above, the master drive unit may include a planetary steering system for speed reduction and to provide demanded steering torque, where the master drive unit may be arranged in a ring gear output configuration with a first speed reduction ratio or a carrier output configuration with a second speed reduction ratio. An example of a master drive unit with the carrier output configuration is shown in cross section views in FIGS. 3A, 3B, and 3C. An example of a master drive unit with the ring gear output configuration is shown in cross section views in FIGS. 4A, 4B, and 4C. The planetary steering system of the master drive unit of FIGS. 3A, 3B, and 3C is shown in FIGS. 5-8. The planetary steering system of the master drive unit of FIGS. 4A, 4B, and 4C is shown in FIGS. 9-12. By arranging the planetary steering system inline (e.g., rather than being non-coaxial to the traction motor), the master drive unit of the present disclosure may be more space-efficient than conventional master drive units while still allowing for speed reduction and torque increase from the steering motor in either the ring gear output configuration or the carrier output configuration, according to a desired speed reduction ratio or output torque.

It is to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

Turning to FIG. 1, a vehicle 100 with a master drive unit 102 in accordance with the present disclosure is shown schematically. A set of reference axes 150, including an x-axis, a y-axis, and a z-axis, are shown in FIGS. 1-12 for comparison of orientations of views shown in the figures. The z-axis may be a vertical direction and the x-axis and y-axis may be lateral directions. As such, the z-axis may be parallel with gravity and the x-axis and y-axis may be perpendicular with gravity. However, other orientations are also possible.

The vehicle 100 may be a forklift, in at least some examples. In other examples, the vehicle 100 may be other machines with self-propulsion systems where power is provided to the master drive unit 102 from an energy storage device 108 for propulsion and steering. The vehicle 100 may comprise three or more wheels 104. The master drive unit 102 may be rotationally coupled to one of the wheels 104 as indicated by dashed line 106. For example, the master drive unit 102 may be rotationally coupled to the wheel 104 via a gearbox. In some examples, there may be fewer master drive units 102 than wheels 104. For example, either front wheels or rear wheels may be coupled to master drive units. In examples where the vehicle is a single wheel drive vehicle, such as a forklift, there may be a single master drive unit 102. In other examples, there is a master drive unit 102 for each wheel 104.

The master drive unit 102 may comprise electric machines, including a traction motor and a steering motor. In this way, the master drive unit 102 may drive traction and steering of the wheels 104 in order to propel and direct the vehicle 100. Specifically, the traction motor may rotate the wheel 104 about its central axis parallel with the y-axis (e.g., axis 214 of FIG. 2) to propel the vehicle 100 and the steering motor may rotate parts of the master drive unit about a vertical axis parallel with the z-axis (e.g., the axis 212 of FIG. 2) to steer the vehicle 100 (e.g., adjust direction of propulsion). Thus, the vehicle 100 may be an electric vehicle driven by the electric motors, or a hybrid vehicle driven by an engine in addition to the electric motors. In some examples, there may be further movers driving propulsion of the vehicle 100. In at least some examples, the master drive unit 102 may be oriented vertically about an axis perpendicular to a direction of propulsion. Further, the master drive unit 102 may be positioned vertically above the wheel 104. Thus, the master drive unit 102 may be a vertical drive unit.

The electric machines of the master drive unit 102 may be powered via energy from the energy storage device 108. In one example, the energy storage device 108 is a battery configured to store electrical energy. An inverter may be arranged between the energy storage device 108 and the master drive unit 102 and configured to adjust direct current (DC) to alternating current (AC) or vice versa. The electric machines (e.g., traction motor and steering motor) of the master drive unit 102 may be motors adapted to receive power from the energy storage device 108, motor/generators adapted to receive power from and provide power to the energy storage device 108, or a combination thereof.

Adjustment of the master drive unit 102, including adjustment of motor speeds of the master drive unit 102, may be executed based on a vehicle control system 154, including a controller 156. Controller 156 may be a microcomputer, including elements such as a microprocessor unit, input/output ports, an electronic storage medium for executable programs and calibration values, e.g., a read-only memory chip, random access memory, keep alive memory, and a data bus. The storage medium can be programmed with computer readable data representing instructions executable by a processor.

Controller 156 may receive various signals from sensors 158 coupled to various regions of vehicle 100. For example, the sensors 158 may include sensors at the traction motor, the steering motor, or another mover (e.g., electric motor, engine, etc.) to measure speed and temperature thereof. Upon receiving the signals from the various sensors 158, controller 156 processes the received signals, and employs various actuators 160 of vehicle 100 to adjust operations based on the received signals and instructions stored on the memory of controller 156. The controller 156 may command operations, such as adjusting steering output, for example by adjusting speed of the steering motor of the master drive unit 102.

Turning to FIG. 2, a master drive unit 200 in accordance with the present disclosure is shown. The master drive unit 200 may be an example of the master drive unit 102 of FIG. 1. As such, one or more of the master drive unit 200 may be included in a vehicle (e.g., the vehicle 100 of FIG. 1) for propulsion and steering.

The master drive unit 200 may include a traction motor 202, a steering motor 204, a mounting frame 206, a planetary steering system 208, and a gearbox 210. The traction motor 202, the steering motor 204, the mounting frame 206, the planetary steering system 208, and the gearbox 210 may be vertically stacked along a vertical axis 212. The traction motor 202, the steering motor 204, and the planetary steering system 208 may be ordered in series along the axis 212, rather than having two or more of the aforementioned components positioned side by side relative to the axis 212. For example, the traction motor 202 may be stacked on top of the steering motor 204. Specifically, the traction motor 202 may be mounted directly atop, or directly above, the steering motor 204. The steering motor 204 may be mounted directly onto the mounting frame 206. The traction motor 202 may be fixed to the mounting frame 206 via the steering motor 204. Both the steering motor 204 and the traction motor 202 may be mounted above the mounting frame 206. Some components of the planetary steering system 208 may be mounted to the mounting frame 206. The planetary steering system 208 may be laterally aligned with the mounting frame 206 such the planetary steering system 208 is mounted partially within the mounting frame 206. For example, the mounting frame 206 may circumferentially surround the planetary steering system 208, and at least a portion of the planetary steering system 208 may extend partially below the mounting frame 206. The gearbox 210 may be positioned below the planetary steering system 208. In this way, the steering motor 204 may be interposed between the traction motor 202 and the mounting frame 206, the mounting frame 206 may be interposed between the steering motor 204 and the planetary steering system 208, and the planetary steering system 208 may be interposed between the mounting frame 206 and the gearbox 210.

Further, the traction motor 202, the steering motor 204, and the planetary steering system 208 may be aligned coaxially about the vertical axis 212. The traction motor 202, the steering motor 204, and the planetary steering system 208 may be arranged inline, rather than in parallel or side by side. Thus, the master drive unit 200 may also be referred to as inline master drive unit 200. Elements described as inline may be arranged in series and centered on a common axis (e.g., the vertical axis).

An output of the traction motor 202 may rotate a wheel 216, such as wheels 104 of FIG. 1, about a lateral axis 214. The lateral axis 214 is lateral and perpendicular to the vertical axis 212, in at least some examples. For example, a shaft of the traction motor 202 may extend through the steering motor 204 to the gearbox 210 and indirectly drive rotation of the wheel 216 about the axis 214 via gears and shafts of the gearbox 210. An output of the steering motor 204 may rotate the gearbox 210 via the planetary steering system 208, and consequently rotate the wheel 216 about the vertical axis 212, thereby steering the vehicle. The vertical axis 212 and the lateral axis 214 may intersect in some examples. For example, the vertical axis 212 may intersect an axial center of the wheel 216 such that the vertical axis 212 and the lateral axis 214 intersect. In other examples, the vertical axis 212 and the lateral axis 214 may be offset in the x-direction, or in other words the axes may lie in different y-z planes, such that the vertical axis 212 and the lateral axis 214 do not intersect. For example, the vertical axis 212 may not extend through an axial center of the wheel 216 such that the vertical axis 212 and the lateral axis 214 do not intersect. Additionally, the vertical axis 212 may be offset (e.g., in a y-direction) from a midpoint along a length 220 of the wheel 216 in some examples. In other examples, the vertical axis may extend through the midpoint of the length 220. The wheel 216 may be secured relative to the vertical axis 212 according to a desired center of rotation of the wheel (which may or may not be a center of the wheel in any of the three reference dimensions).

As described above, the master drive unit 200 may be configured in a carrier output configuration or a ring gear output configuration, where the carrier output configuration and the ring gear output configuration have different speed reduction ratios and correspondingly different output toques. Thus, a configuration of the master drive unit 200 may be selected according to an application of the master drive unit 200, and an according desired speed reduction ratio from the steering motor 204.

Turning to FIGS. 3A, 3B, and 3C, an example of a master drive unit 300 with a carrier output configuration is shown in a first view 310, a second view 320, and a third view 390, respectively. The third view 390 shows an enlarged portion of the first view 310. The master drive unit 300 is an embodiment of the master drive unit 200 where the planetary steering system 208 is configured for output of the steering motor 204 via a carrier 302. As such, the master drive unit 300 may be an inline master drive unit in accordance with the present disclosure having the traction motor 202, the steering motor 204, and a speed reduction system (e.g., planetary steering system 208) vertically stacked inline. The master drive unit 300 is shown in cross section views in the first view 310 and the second view 320, where the cross sections are taken in y-z planes.

The master drive unit 300 includes the traction motor 202, the steering motor 204, the mounting frame 206, the planetary steering system 208, and the gearbox 210. At least some components of the master drive unit 200 may be enclosed within a housing 314. For example, components positioned vertically above the mounting frame 206 may be enclosed by the housing 314 and the mounting frame 206. The housing 314 may comprise one or more pieces. For example, a first piece may surround the traction motor 202 and a second piece may surround the steering motor 204.

A shaft 312 driven by the traction motor 202 may extend through both the steering motor 204 and the traction motor 202 along the vertical axis 212. Further, the steering motor 204 and the traction motor 202 may be coaxially positioned about the vertical axis 212. In this way, the steering motor 204 and the traction motor 202 may be configured inline, rather than non-coaxially, or in parallel. The vertical axis 212 may be a rotational axis about which the shaft 312 rotates when driven by the traction motor 202. The shaft 312 may rotationally couple with components of the gearbox 210 in order to drive output rotation of the wheel 216 about the lateral axis 214. For example, the shaft 312 may drive rotation of a drive gear 318 that is rotationally coupled to gears 328 and shafts 322 housed within a gearbox housing 324. Rotation of the drive gear 318 ultimately rotates the wheel 216 about a lateral axis (e.g., the axis 214 of FIG. 2), thereby providing traction.

The shaft 312 may extend through the planetary steering system 208 and rotate independently of components of the planetary steering system 208. In this way, steering may be performed independently from, and concurrently with, traction. The planetary steering system 208 may include the carrier 302, planet gears 304, a sun gear 306, a slew ring bearing 308, and a ring gear 330. The planetary steering system 208 may provide speed reduction and torque increase from the steering motor 204. In this way, the planetary steering system 208 may be configured as an inline speed reduction system, rather than a drop box positioned non-coaxially with the traction motor. Some components of the planetary steering system 208 may be fixed to the mounting frame 206, thereby fixing such components of the planetary steering system rotationally stationary relative to the housing 314. Other components of the planetary steering system 208 may be rotationally coupled to the gearbox housing 324 and rotationally independent, or rotationally separate, of the mounting frame 206. In this way, the gearbox housing 324 may rotate while the traction motor 202 and the steering motor 204 are held stationary by the stationary mounting frame 206, thereby steering the wheel 216.

The sun gear 306 may be rotated by the steering motor 204. In this way, the sun gear 306 may function as a shaft of the steering motor 204. The sun gear 306 may be hollow so as to circumferentially surround the shaft 312 extending through the steering motor 204. The sun gear 306 and the shaft 312 may rotate independently of one another. For example, a bearing may be positioned between the shaft 312 and the sun gear 306. Additionally or alternatively, the sun gear 306 and the shaft 312 may be proportioned such that the sun gear 306 and the shaft 312 are coaxially positioned and spaced apart with a circumferential gap therebetween, thereby preventing interference with rotation of each other. Hence, the sun gear 306 and the shaft 312 may be rotationally independent of one another such that signals to drive the traction motor 202 and the steering motor 204 (e.g., from a controller such as the controller 156 of FIG. 1) may be received and executed concurrently.

The sun gear 306 may be shaped as a hollow cylindrical shaft with radially protruding gear teeth 326 at one end. For example, the sun gear 306 may extend at least partially axially through the steering motor 204, and further beyond the steering motor 204 towards the wheel 216. The sun gear 306 may extend into an x-y plane where the mounting frame 206 lies. However, the sun gear 306 may not be rotationally coupled to the mounting frame 206.

The planet gears 304 may be centered about upward extending protrusions 332 of the carrier 302. The upward extending protrusions 332 may protrude upwards (e.g., in a positive z-direction) through the planet gears 304. The upward extending protrusions 332 may be uniformly radially arranged about the axis 212 such that the planet gears 304 are also uniformly radially arranged about the axis 212. In this way, the planet gears 304 may be arranged radially about the sun gear 306. Teeth of the planet gears 304 may mesh with the radially protruding gear teeth 326 of the sun gear 306 such that the sun gear 306 may rotate the planet gears 304.

The planet gears 304 may be in mesh with both the sun gear 306 and the ring gear 330. The ring gear 330 may circumferentially surround the planet gears 304 and the sun gear 306. Inward protruding teeth of the ring gear 330 may mesh with the teeth of the planet gears 304. The ring gear 330 may be fixed to the mounting frame 206. The ring gear 330 may also be fixed with a mounting flange 336 to which the steering motor 204 is attached. The ring gear 330 and the mounting flange 336 may be integral as shown in FIGS. 3A, 3B, and 3C. However, in other examples, the ring gear 330 and the mounting flange 336 may be otherwise rotationally fixed, such that the mounting flange 336 circumferentially surrounds the ring gear 330 with teeth of the ring gear 330 facing inwards and in mesh with the planet gears 304. As the mounting frame 206 is stationary within the vehicle (e.g., due to fixation with other vehicle structures) and not able to rotate or otherwise shift relative to the vehicle, the ring gear 330 may also be fixed in place (e.g., rotationally and translationally stationary relative to the rest of the vehicle) and unable to rotate in the master drive unit 300 in the carrier output configuration.

As used herein, rotational fixation may indicate the components rotate with the same rotational speed and the same rotational axis, while rotational coupling may indicate the components rotate each other but may or may not rotate with the same rotational speed or rotational axis and rotationally independent may indicate the referenced components are not rotationally coupled. As used herein, stationary may indicate the component is stationary relative to the rest of the vehicle (e.g., vehicle 100) where the master drive unit is implemented.

An outer race 342 of the slew ring bearing 308 may also be fixed to the mounting frame 206. For example, the slew ring bearing 308 may be positioned below the ring gear 330 and the outer race 342 may be fixed to the mounting frame 206 via fasteners 340 (e.g., bolts) extending through the mounting flange 336 and into the outer race 342. In such an example, the fasteners 340 and the fasteners 350 may axially compress the mounting flange 336 between the mounting frame 206 and the outer race 342, thereby fixing the mounting flange 336 and the ring gear 330. An inner race 344 of the slew ring bearing 208 may be rotationally fixed to the carrier 302. For example, the carrier 302 and the inner race 344 may be fixed to the gearbox housing 324 via fasteners 356 (e.g., bolts) extending through the carrier 302 and the inner race 344, and into the gearbox housing 324. In this way, the slew ring bearing 308 may rotationally decouple (e.g., separate) the ring gear 330 from the carrier 302 such that in the carrier output configuration, the carrier 302 may rotate while the ring gear 330 is rotationally stationary.

The slew ring bearing 308 (including the outer race 342 and the inner race 344), the ring gear 330, and the sun gear 306 may be concentric about the axis 212, where the axis 212 is an axis of rotation of the inner race 344, the carrier 302, and the sun gear 306. The carrier 302 may be centered about the axis 212 such that the axis 212 extends through an axial center of the carrier 302.

Thus, in the carrier output configuration, as the sun gear 306 is rotated by the steering motor 204 about the axis 212, the planet gears 304 and the upward extending protrusions 332 may rotate about the axis 212, thereby rotating the carrier 302 about the axis 212. Further, the carrier 302 may be rotationally fixed with the gearbox housing 324. Thus, in a master drive unit in a carrier output configuration, such as the master drive unit 300, the steering motor 204 may rotate the carrier 302, thereby rotating the gearbox housing 324, and consequently rotating the wheel 216 about the vertical axis 212.

When the steering motor 204 receives a signal to drive (e.g., from a controller such as the controller 156 of FIG. 1), the sun gear 306 rotates and in turn rotates planet gears 304. Because the ring gear 330 is rotationally stationary, the carrier 302 may rotate the gearbox housing 324 to which the wheel 216 is rotationally coupled, resulting in steering action. A first speed reduction ratio for a master drive unit in a carrier output configuration (e.g., the master drive unit 300) may be calculated by equation (1) below:

$$first speed reduction ratio = 1 + \frac{number of ring gear teeth}{number of sun gear teeth} \qquad ( 1 )$$

where the number of ring gear teeth is a number of teeth protruding internally from the ring gear 330 and the number of sun gear teeth is a number of radially outward protruding teeth 326 from the sun gear 306.

Further details as to the planetary steering system 208 in the carrier output configuration are provided below in regards to FIGS. 5-8. Now referencing FIGS. 3A, 3B, 3C, and 5, a cross section view 500 shows the planetary steering system 208 in the carrier output configuration, such as in the master drive unit 300 of FIGS. 3A, 3B, and 3C.

The upward extending protrusions 332 may extend upwards from the carrier 302. The upward extending protrusions 332 may be rigidly fixed to or integral with the carrier 302. The upward extending protrusions 332 may extend through the planet gears 304 such that the planet gears circumferentially surround and rotate about the upward extending protrusions 332. A circlip 502 may circumferentially surround each of the protrusions 332 such that the planet gears 304 are axially fixed between the circlip 502 and the carrier 302.

The carrier 302 may be positioned below the sun gear 306 and the planet gears 304 with the upward extending protrusions 332 rigidly fixed to a top of the carrier 302 and extending upwards through the planet gears 304. The upward extending protrusions 332 may extend from rounded edges 528 that connect the carrier 302 and the upward extending protrusions 332. Hence, the planet gears 304 being rotated around the axis 212 by the sun gear 306 may prompt the carrier 302 to rotate about the axis 212.

As described above, the planet gears 304 may be arranged radially around and in mesh with the sun gear 306. The ring gear 330 may circumferentially surround and be in mesh with the planet gears 304. The sun gear 306, the ring gear 330, and the planet gears 304 may be aligned in a lateral plane. For example, a first top surface 504 of the ring gear 330 may be flush with second top surfaces 506 of the planet gears 304 and a third top surface 508 of the protruding teeth 326 of the sun gear 306. Additionally or alternatively, a first bottom surface 514 of the ring gear 330 may be flush with second bottom surfaces 516 of the planet gears 304 and a third bottom surface 518 of the protruding teeth 326 of the sun gear 306. Further, the sun gear 306, the ring gear 330, and the planet gears 304 may be laterally aligned with a mounting frame such as the mounting frame 206. Thus, some of the planetary steering system 208 may be mounted within the mounting frame 206. Other components, such as the carrier 302 may be below the mounting frame 206.

The mounting flange 336 may include protrusions 524 and recesses 526 adapted to receive a motor, such as the steering motor 204. In this way, the motor may be directly mounted onto the mounting flange 336, and indirectly fixed to the mounting frame 206. Further, the ring gear 330 which is integral with or rotationally fixed to the mounting flange 336 may also be rotationally stationary such that the sun gear 306 and planet gears 304 drive rotation of the carrier 302, rather than rotation of the ring gear 330.

The sun gear 306 may be separated from the carrier 302 by a spacer 338. The sun gear 306 may include a ring-shaped protrusion 510 extending downwards such that the protrusion 510 is in face sharing contact with the spacer 338. As used herein, downwards may indicate a direction oriented towards the wheel (e.g., wheel 216 of FIGS. 2-4B), and upwards may indicate a direction oriented towards the traction motor (e.g., traction motor 202 of FIGS. 2-4B). Additionally or alternatively, downwards and upwards may be directions with respect to gravity. The spacer 338 may be inset into a recess 520 in a top of the carrier 302. Further, the spacer 338 may be fixed with the carrier 302 and in face sharing contact with the sun gear 306. The sun gear 306 may rest upon the spacer 338 via the protrusion 510. The spacer 338 may reduce friction between the sun gear 306 and the carrier 302. The protrusion 510 may space the sun gear 306 from the carrier 302 at other points than the spacer 338, thereby creating spaces 522 vertically interposed between the sun gear 306 and the carrier 302 such that the sun gear 306 and the carrier 302 rotate with reduced friction or other interference with relative rotation. The sun gear 306 and the carrier 302 may not be directly rotationally coupled due to the spacer 338. Thus, the sun gear 306 and the carrier 302 may rotate with different rotational speeds. For example, the carrier 302 may have a slower rotational speed than the sun gear 306 by a factor equal to the speed reduction ratio provided in equation (1) above. Said another way, a speed reduction ratio between the sun gear 306 as the input and the carrier 302 as the output may be equal to the first speed reduction ratio, where the first speed reduction ratio is one plus a ratio of the number of ring gear teeth to the number of sun gear teeth.

The carrier 302 shape may include circular steps centered around the axis 212. For example, the carrier 302 may include a first step 532, a second step 534, and a third step 536. The first step 532 may be the largest in diameter and at the bottom of the carrier. The second step 534 may be smaller than the first step 532 and larger than the third step 536 in diameter. The second step 534 may be positioned between the first step 532 and the second step 534. The first step 532, the second step 534, and the third step 536 may have chamfered corners. The stair-step shape of the carrier 302 may allow for the slew ring bearing 308 to be positioned in a space 540 between the ring gear 330 and the carrier 302 such that the slew ring bearing 308 circumferentially surrounds the second step 534 and the third step 536. For example, the inner race 344 of the slew ring bearing 308 may be positioned between a top of the first step 532 and a bottom of the ring gear 330 such that the inner race 344 is in face sharing contact with the carrier 302 and not in contact with the ring gear 330. Additionally, the outer race 342 of the slew ring bearing 308 may fit into a recess 538 in the bottom of the ring gear 330 such that the outer race 342 is in face sharing contact with the ring gear 330 and not with the carrier 302. Further, the stair-step shape of the carrier 302 may allow for fixation of the carrier 302 with the gearbox housing 324. For example, the gearbox housing 324 may have complementary geometry to the carrier 302 such that the gearbox housing 324 may fit into a hollow center 548 of the carrier 302 where the gearbox housing 324 is in face sharing contact with at least part of an inner surface of the carrier 302. For example, the gearbox housing 324 may be in face sharing contact with first bottom surface 542 of the first step 532 and second bottom surface 544 of the second step 534. The gearbox housing 324 may be spaced away from the sun gear 306 by the carrier 302, the space 522, and part of the hollow center 548.

In the carrier configuration, the sun gear 306 and the carrier 302 may be rotationally coupled via the planet gears 304, and not directly at an interface therebetween where the spacer 338 is positioned or by the slew ring bearing. Thus, the sun gear 306 and the carrier 302 may rotate at different speeds, as described above. Specifically, the rotational speed of the carrier 302 about the vertical axis 212 may be different than the rotational speed of the sun gear 306 about the vertical axis 212 by a factor equal the first speed reduction ratio provided in equation (1) above. Because the carrier 302 is rotationally fixed to the gearbox housing 324, a difference in rotational speeds of the sun gear 306 and the gearbox housing 324 about the vertical axis 212 may be a factor equal to the first speed reduction ratio provided in equation (1).

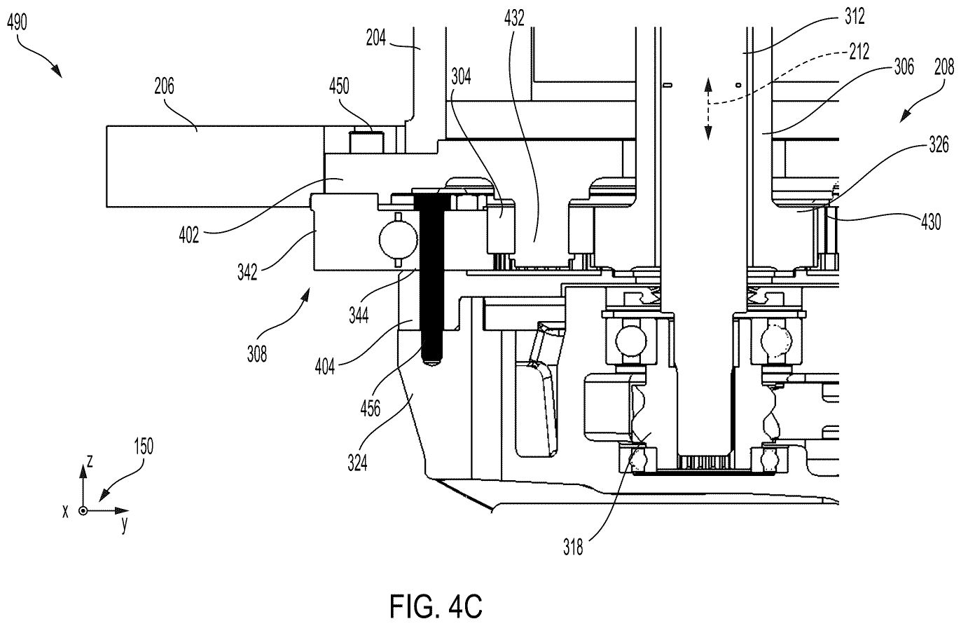

Further, now referencing FIGS. 3A, 3B, 3C, and 6, a view 600 shows a carrier configuration of the planetary steering system 208. In the carrier configuration, the carrier 302 may be fastened to the inner race 344 and the ring gear 330 may be fastened to the outer race 342. For example, the carrier 302 may include holes 606 adapted to receive fasteners 356 extending vertically through the inner race 344, the first step 532, and into the gearbox housing 324. Likewise, the mounting flange 336 may include holes 608 adapted to receive fasteners 340 extending vertically through the mounting frame 206, the ring gear 330, and the outer race 342. Further, the mounting flange 336 may include protrusions 602 extending radially outwards with holes 604 formed axially into the protrusions 602 and adapted to receive fasteners 350 for fastening the mounting flange 336 (and therefore the ring gear 330) to the mounting frame 206.

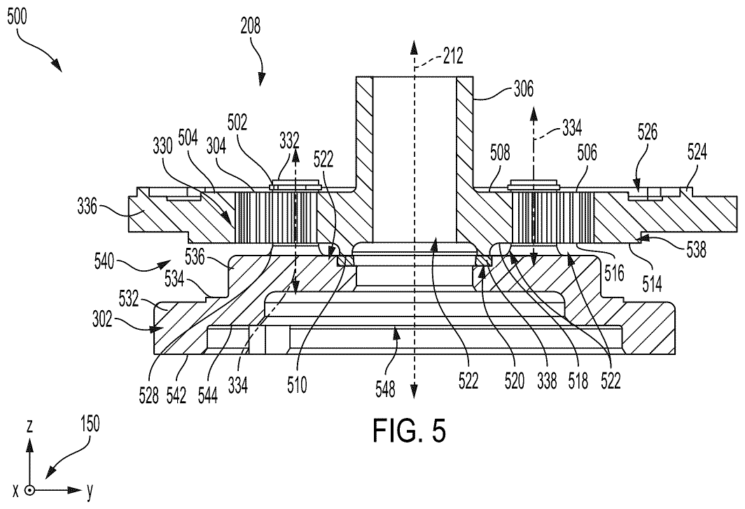

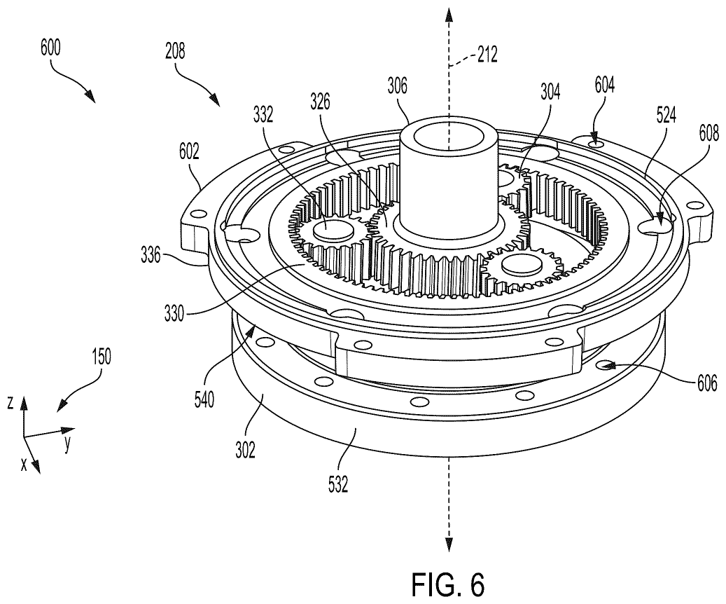

Turning to FIGS. 7 and 8, the planet gear 304 is shown in the carrier output configuration in a first view 700 and a second view 800. A bearing 702 may be positioned around the protrusion 332 with the planet gear 304 surrounding the bearing 702 such that the planet gear 304 may rotate freely about the upward extending protrusion 332. The bearing 702 may be a bush bearing, needle roller bearing, or the like. The circlip 502 may be positioned surrounding the upward extending protrusion 332 and in face sharing contact with a flat surface 704 of the bearing 702. Additionally, the circlip 502 may be positioned in a groove 706 around a circumference of the upward extending protrusion 332. The bearing 702 may be in face sharing contact with a ledge 708 jutting radially outwards from the upward extending protrusion 332 such that the planet gear 304 is fixed between the circlip 502 and the ledge 708. The ledge 708 may be shaped according to a curved surface 710 of the bearing 702 (e.g., with similar profile shape in the cross section) such that the ledge 708 and the curved surface 710 are in face sharing contact. In this way, the bearing 702 may be axially fixed to the upward extending protrusion 332, thereby ensuring smooth rotation of the planet gear 304 relative to the upward extending protrusion 332 about the axis 334. As described above, there may be three or more upward extending protrusions 332 and correspondingly three or more planet gears 304. Each of the three or more upward extending protrusions 332 may be shaped and sized the same as one another. Likewise, each of the three or more planet gears 304 may be shaped and sized the same as one another.

In this way, in the carrier output configuration, the planet gears 304 may rotate about the rotational axes 334 and the vertical axis 212. More generally, a master drive unit in accordance with the present disclosure in a carrier output configuration may rotate a carrier having upward extending protrusions such that the carrier rotates a gearbox housing, resulting in steering action of a wheel.

Alternatively, in a ring gear output configuration, the sun gear 306 may rotate the planet gears 304 about planet axes 334 and not about the vertical axis 212, as described further below in regards to FIGS. 4A-4C and 9-12. Turning to FIGS. 4A, 4B, and 4C, a first view 410, a second view 420, and a third view 490 are respectively shown of a master drive unit 400 in a ring gear output configuration. The third view 490 is an enlarged portion of the first view 410.

The master drive unit 400 includes the sun gear 306 driven by the steering motor 204, the shaft 312 extending through the sun gear and driven by the traction motor 202, and the mounting frame 206 to which the steering motor 204 is mounted to and above. Additionally, the planet gears 304 are radially arranged about and in mesh with the sun gear 306. Further, the outer race 342 is fixed to the mounting frame 206 which is rotationally fixed, as described above in regards to the carrier output configuration.

In both the carrier output configuration and the ring gear configuration, the planetary steering system may comprise the sun gear 306 directly driven by the steering motor 204, three or more planet gears 304 arranged around and in mesh with the sun gear, a ring gear (e.g., ring gear 330 or ring gear 430) circumferentially surrounding and in mesh with the planet gears, the slew ring bearing 308 comprising the inner race 344 and an outer race 342, and a carrier (e.g., carrier 302 or carrier 402) comprising three or more protrusions (e.g., upward extending protrusions 332 or downward extending protrusions 432) about which the planet gears rotate. Additionally, in both the carrier output configuration and the ring gear output configuration, the outer race 342 may be mounted to the mounting frame 206 such that the outer race 342 is rotationally coupled to the traction motor 202 and the steering motor 204, and the inner race 344 is rotationally fixed to the gearbox housing 324 such that the gearbox housing 324 and the mounting frame 206 are rotationally separated by the slew ring bearing 308. Rotation of the sun gear 306 may drive rotation of the gearbox housing 324 via the planetary steering system 208 in both the carrier output configuration and the ring gear output configuration such that a rotational speed of the gearbox housing 324 is less than a rotational speed of the sun gear 306.

However, the ring gear configuration differs from the carrier output configuration in comparing the carriers 302 and 402 and the ring gears 330 and 430, as well as a magnitude of an output rotational speed of the gearbox housing 324 relative to the sun gear 306. As used herein, a carrier is a component comprising protrusions about which planet gears rotate. As used herein, a ring gear is a gear with inward extending teeth adapted to mesh with planet gears. For example, carrier 402 may be positioned above the slew ring bearing 308 and fixed to the outer race 342, whereas in the master drive unit 300 of FIGS. 3A-3C in the carrier output configuration, the carrier 302 may be positioned below the slew ring bearing 308 and fixed to the inner race 344. Further, the planet gears 304 rotate about protrusions 432 extending from the carrier 402, where the protrusions 432 extend downwards. Additionally, ring gear 430 may be integral with the inner race 344 such that the inner race 344 comprises inward teeth in mesh with the planet gears 304. Alternatively, the ring gear 430 may be concentrically fixed with the inner race 344 such that the inner race 344 does not comprise teeth, but is rotationally coupled to the ring gear 330 comprising inward teeth in mesh with the planet gears 304. For example, the ring gear 430 may be bolted, press fitted, or otherwise rigidly fixed to the inner race 344 such that the inner race 344 and the ring gear 430 rotate together at the same rotational speed in examples where the inner race 344 and the ring gear 430 are separate components.

As the outer race 342 may be stationary, and the inner race 344 may rotate freely from the outer race 342, the ring gear 330 (which may be integral with or rotationally fixed to the inner race 344) may rotate according to rotation of the sun gear 306. In this way, the slew ring bearing 308 may rotationally decouple the ring gear 430 with the carrier 402 such that the ring gear 430 may rotate while the carrier 402 is rotationally stationary. The ring gear 430 may additionally be fixed to a mounting flange 404, where the mounting flange 404 connects the ring gear 430 with the gearbox housing 324 such that the ring gear 430 and the gearbox housing 324 rotate with the same speed. Thus, the wheel 216 may rotate about the axis 212 with the same speed as the ring gear 430, resulting in steering action where the planetary steering system 208 is a speed reduction system for the steering motor 204.

In the ring gear output configuration, as the sun gear 306 is rotated by the steering motor 204 about the axis 212, the protrusions 432 may remain stationary while the planet gears 304 rotate therearound, thereby rotating the ring gear 430 about the axis 212. Further, the ring gear 430 may be fixed with the gearbox housing 324. Thus, in a master drive unit in a carrier output configuration, such as the master drive unit 400, the steering motor 204 may rotate the ring gear 430, thereby rotating the gearbox housing 324, and consequently rotating the wheel 216 about the vertical axis 212.

When the steering motor 204 receives a signal to drive (e.g., from a controller such as the controller of FIG. 1), the sun gear 306 rotates and in turn rotates planet gears 304. Because the carrier 402 is fixed, the ring gear 430 may rotate the gearbox housing 324 to which the wheel 216 is rotationally coupled, resulting in steering action. A second speed reduction ratio for the ring gear output configuration may be calculated by equation (2) below:

$$second speed reduction ratio = \frac{number of ring gear teeth}{number of sun gear teeth} \qquad ( 2 )$$

where the number of ring gear teeth is a number of teeth protruding internally from the ring gear 430 and the number of sun gear teeth is the number of radially protruding teeth 326 from the sun gear 306.

Further details as to the planetary steering system 208 in the ring gear output configuration are provided below in regards to FIGS. 9-12. Now referencing FIGS. 4A, 4B, 4C, and 9, a cross section view 900 shows the planetary steering system 208 in the ring gear output configuration, such as in the master drive unit 400 of FIGS. 4A, 4B, and 4C.

The downward extending protrusions 432 may extend downwards from the carrier 402. The downward extending protrusions 432 may be rigidly fixed to or integral with the carrier 402. The downward extending protrusions 432 may extend through the planet gears 304 such that the planet gears 304 circumferentially surround and rotate about the axes 334 extending centrally through the downward extending protrusions 432.

The carrier 402 may be positioned above the radially protruding teeth 326 and the planet gears 304 with the downward extending protrusions 432 rigidly fixed to a bottom of the carrier 402 and extending downwards through the planet gears 304. The downward extending protrusions 432 may extend from rounded edges 928 that connect the carrier 402 and the downward extending protrusions 432. The rounded edges 928 may be shaped similarly to as described with regards to the rounded edges 528 of the carrier 302 shown in FIGS. 5, 7 and 8 and oriented oppositely with respect to the z-axis.

As described above, the planet gears 304 may be arranged radially around and in mesh with the sun gear 306. The ring gear 430, which may be integral or otherwise rigidly fixed with the inner race 344, may circumferentially surround and be in mesh with the planet gears 304. The teeth 326 of the sun gear 306, the ring gear 330, and the planet gears 304 may be aligned in a lateral plane. For example, a first top surface 904 of the ring gear 430 may be coplanar with the second top surfaces 506 of the planet gears 304 and the third top surface 508 of the protruding teeth 326 of the sun gear 306. Additionally or alternatively, a first bottom surface 914 of the ring gear 330 may be coplanar with fourth bottom surfaces 916 of the protrusions 432 and the third bottom surface 518. Alternatively, the protrusions 432 may extend further such that the first bottom surface 914 of the ring gear 330 may be coplanar with the second bottom surfaces 516 of the planet gears 304 and the third bottom surface 518 of the protruding teeth 326 of the sun gear 306.

The carrier 402 may be spaced away from the sun gear 306 with a circumferential gap 924 therebetween. Further, the carrier 402 may be vertically spaced away from the top surfaces 506 of the planet gears 304, the top surface 904 of the ring gear 430, and the top surface 508 of the protruding teeth 326, with spaces 922 vertically interposed therebetween. In this way, the inner race 344 and the ring gear 430 may rotate together relative to the carrier 402 without friction therebetween. Additionally, the sun gear 306 may not be in contact with the carrier 402 such that the sun gear 306 may rotate relative to the carrier 402.

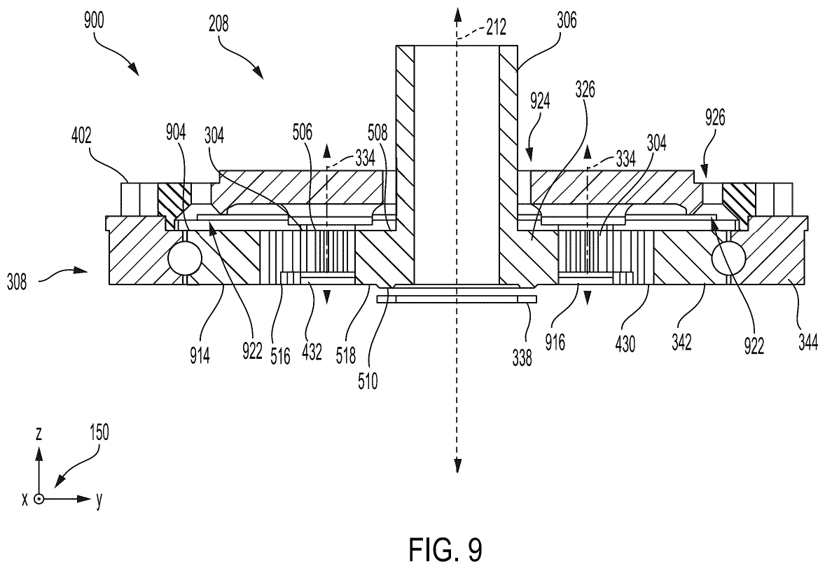

Turning to FIG. 10, an enlarged view 1000 of a portion 406 of FIG. 4B is shown. As described above, in the ring gear output configuration, the ring gear 430 may be fastened to or integral with the inner race 344 and the carrier 402 may be fastened to the outer race 342. For example, the carrier 402 may comprise through holes for fasteners 450 to extend through the carrier 402 and into the outer race 342, thereby attaching the carrier 402 to the outer race 342. Additionally, the inner race 344 may be fastened to the mounting flange 404 and the gearbox housing 324 via fasteners 456, each of the fasteners 456 extending through a through hole 1006 in the inner race 344, a through hole 1008 in the mounting flange 404, and a blind hole 1010 (e.g., tapped hole) in the gearbox housing 324, thereby rotationally fixing the inner race 344, the mounting flange 404, and the gearbox housing 324. Further, the outer race 342 may be secured to the mounting frame 206 by the fasteners 340, as described above with regards to the carrier output configuration. The outer race 342 may include a protrusion 1004 that abuts a protrusion 1002 of the carrier 402. In this way, the outer race 342 and the carrier 402 may be centered.

The mounting flange 404 may include a bottom surface shaped similarly to the carrier 302. For example, the mounting flange 404 may include a stair-step shape adapted to receive the gearbox housing 324 such that the mounting flange 404 is in face sharing contact with the gearbox housing 324. For example, the mounting flange 404 may include a first step 1032, a second step 1034, and a third step 1036. The first step 1032 may be the largest in diameter and at the bottom of the carrier. The second step 1034 may be smaller than the first step 1032 and larger than the third step 1036 in diameter. The second step 1034 may be positioned between the first step 1032 and the second step 1034. In this way, the stair-step shape of the mounting flange 404 may allow for fixation of the mounting flange 404 with the gearbox housing 324. For example, the gearbox housing 324 may have complementary geometry to the mounting flange 404 such that the gearbox housing 324 may fit into a hollow center 1048 of the mounting flange 404 where the gearbox housing 324 is in face sharing contact with at least part of the mounting flange 404.

The carrier 402 may include indents 926 adapted receive a motor, such as the steering motor 204. In this way, the motor may be mounted directly to the carrier 402 and indirectly fixed to the mounting frame 206. Thus, the carrier 402 may perform similar functions as the mounting flange 336 of FIGS. 3A, 3B, and 3C, such as supporting the steering motor 204 and facilitating connection of the steering motor 204 and the mounting frame 206. Due to the fasteners 340 fixing the carrier 402 to the stationary mounting frame 206, the carrier 402 may be rotationally stationary such that the sun gear 306 and planet gears 304 drive rotation of the ring gear 430, rather than rotation of the carrier 402.

The sun gear 306 may be separated from the mounting flange 404 of FIGS. 4A-4C by the spacer 338. As described above, the sun gear 306 may include the ring-shaped protrusion 510 extending downwards such that the protrusion 510 is in face sharing contact with the spacer 338. The spacer 338 may be positioned abutting a ring-shaped protrusion 1014 extending upwards from the mounting flange 404. The spacer 338 may be fixed to the mounting flange 404 and in face sharing contact with the sun gear 306. The spacer 338 may reduce friction between the sun gear 306 and the mounting flange 404. The protrusion 510 may space the sun gear 306 from the mounting flange 404 at other points than the spacer 338, thereby creating spaces 1016 vertically interposed between the sun gear 306 and the mounting flange 404 such that the sun gear 306 and the mounting flange 404 rotate with reduced friction or other interference with relative rotation.

In the ring gear output configuration, the sun gear 306 and the mounting flange 404 may be rotationally coupled via the planet gears 304, and not at an interface therebetween where the spacer 338 is positioned or by the slew ring bearing 308. Thus, the sun gear 306 and the mounting flange 404 may rotate at different speeds. As the ring gear 430 is rotationally fixed to the mounting flange 404, the ring gear 430 may rotate with a different rotational speed than the sun gear 306. Specifically, the rotational speed of the ring gear 430 about the vertical axis 212 may be different than the rotational speed of the sun gear 306 about the vertical axis 212 by a factor equal to the second speed reduction ratio provided in equation (2) above. The ring gear 430, the inner race 344, the mounting flange 404, and the gearbox housing 324 may rotate with the same rotational speed. Additionally, the ring gear 430, the inner race 344, the mounting flange 404, and the gearbox housing 324 may rotate about the same vertical axis 212. In other words, the ring gear 430, the inner race 344, the mounting flange 404, and the gearbox housing 324 may be directly or indirectly rotationally fixed with each other. Therefore, the rotational speed of the gearbox housing 324 (and the wheel 216) about the vertical axis 212 may be different than the rotational speed of the sun gear 306 about the vertical axis 212 by a factor equal to the second speed reduction ratio provided in equation (2) above. Said another way, a speed reduction ratio between the sun gear 306 as the input and the ring gear 430 as the output may be equal to the second speed reduction ratio, where the second speed reduction ratio is a ratio of the number of ring gear teeth to the number of sun gear teeth.

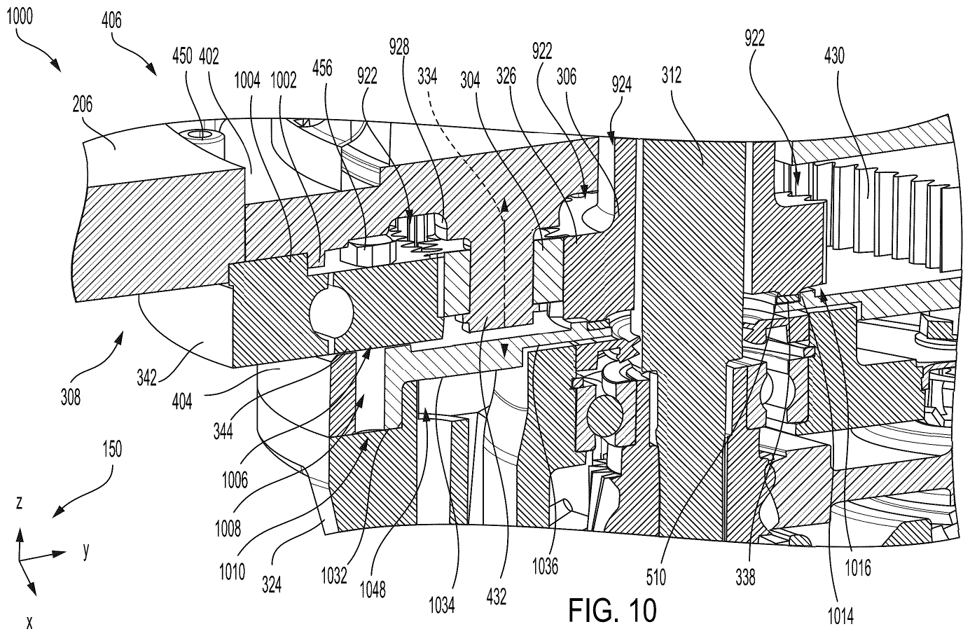

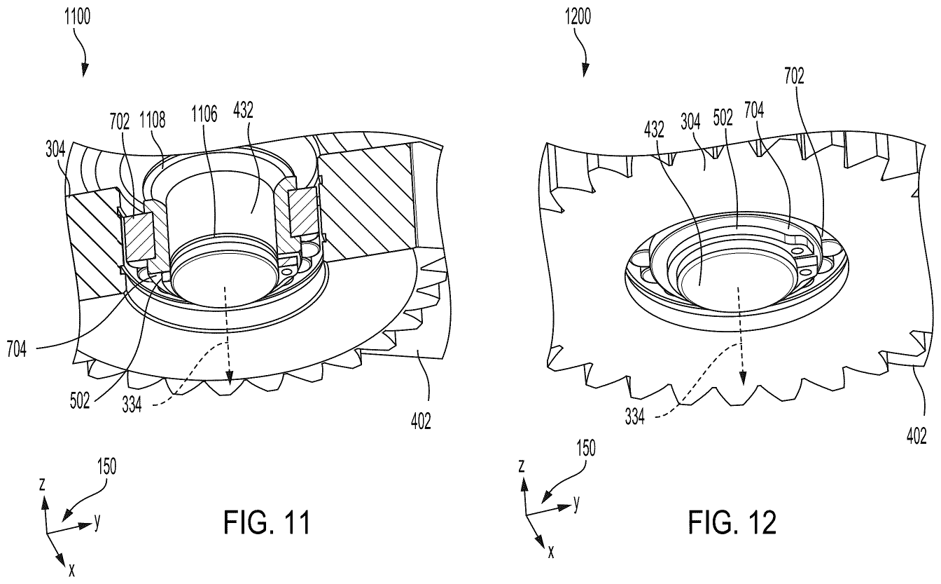

Turning to FIGS. 11 and 12, a first view 1100 and a second view 1200 are shown of the planet gear 304 in the ring gear output configuration where the protrusions 432 of the carrier 402 extend downwards (e.g., in a negative z-direction).

The circlip 502 may circumferentially surround each of the cylindrical protrusions 432 such that the planet gears 304 are axially fixed between the circlip 502 and the carrier 402. Similar to as described above with regards to FIGS. 7 and 8, the bearing 702 may be positioned around the protrusion 432 with the planet gear 304 surrounding the bearing 702 such that the planet gear 304 may rotate freely about the downward extending protrusion 432.

The circlip 502 may be positioned surrounding the downward extending protrusion 432 and in face sharing contact with the flat surface 704 of the bearing 702. Additionally, the circlip 502 may be positioned in a groove 1106 around a circumference of the downward extending protrusion 432. The groove 1106 may be similar to the groove 706 of FIGS. 7 and 8. The bearing 702 may be in face sharing contact with a ledge 1108 extending radially outwards from the downward extending protrusion 432 such that the planet gear 304 is fixed between the circlip 502 and the ledge 1108. The ledge 1108 may be shaped according to the curved surface 710 of the bearing 702 (e.g., with similar profile shape in the cross section) such that the ledge 1108 and the curved surface 710 are in face sharing contact. The ledge 1108 may be shaped similar to the ledge 708 described in regards to FIGS. 7 and 8. In this way, the bearing 702 may be axially fixed to the downward extending protrusion 432, thereby ensuring smooth rotation of the planet gear 304 relative to the downward extending protrusion 432 about the axis 334. As described above, there may be three or more downward extending protrusions 432 and correspondingly three or more planet gears 304. Each of the three or more downward extending protrusions 432 may be shaped and sized the same as one another. Likewise, each of the three or more planet gears 304 may be shaped and sized the same as one another.

Therefore, more generally describing both the carrier output configuration and the ring gear output configuration, the carrier (e.g., carrier 302 or carrier 402) includes protrusions (e.g., protrusions 332 or protrusions 432) extending either upward or downward along rotational axes 334 of the planet gears 304, where the axes 334 are parallel with the vertical axis 212. Additionally, either the ring gear (e.g., ring gear 330 or ring gear 430) or the carrier may be rotationally fixed to the inner race 344 of the slew ring bearing 308 and the other of the ring gear and the carrier may be rotationally fixed to the outer race 342 of the slew ring bearing 308. Additionally, either the ring gear or the carrier may be rotationally stationary and the other of the ring gear or the carrier may be configured to rotate slower than the sun gear 306.

The second speed reduction ratio provided in equation (2) for speed reduction from the sun gear to the ring gear in the ring gear output configuration may be less than the first speed reduction ratio provided in equation (1) for speed reduction from the sun gear to the carrier. Accordingly, torque increase from the sun gear to the ring gear in the ring gear output configuration may be less than torque increase from the sun gear to the carrier in the carrier output configuration. Thus, the planetary steering system 208 may provide two different speed reduction ratios (and two different torque increases) for operation of the master drive unit due to the two different configurations. Hence, a configuration (e.g., carrier output or ring gear output configuration) may be selected according to a desired speed reduction ratio from the steering motor. Further, numbers of teeth on the sun gear and the ring gear may be adjusted to reach a desired speed reduction ratio. In both the ring gear output configuration and the carrier output configuration, the planetary steering system 208 may be aligned below the traction motor 202 and the steering motor 204 such that the planetary steering system 208, the traction motor 202, and the steering motor 204 are aligned coaxially and vertically stacked. In this way, the planetary steering system 208 may be an inline speed reduction system.

The technical effect of the inline master drive unit disclosed herein is to arrange a traction motor and a steering motor inline rather than parallel such that space demand and manufacturing complexity may be reduced. Positioning the motors coaxially with the planetary steering system for speed reduction and torque increase allows for the master drive unit to perform steering and traction functions with reduced footprint, compared to positioning the motors or the planetary steering system side by side.

FIGS. 1-12 show example configurations with approximate position. FIGS. 2-12 are shown approximately to scale; though other relative dimensions may be used. As used herein, the terms “approximately” is construed to mean plus or minus five percent of the range unless otherwise specified.

If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A master drive unit, comprising:
a traction motor;
a steering motor; and
a planetary steering system, wherein the traction motor, the steering motor, and the planetary steering system are mounted inline.

2. The master drive unit of claim 1, wherein the traction motor and the steering motor are mounted above a mounting frame.

3. The master drive unit of claim 2, wherein the planetary steering system is mounted partially within and partially below the mounting frame.

4. The master drive unit of claim 1, wherein the traction motor is mounted above the steering motor and a shaft driven by the traction motor extends through both the traction motor and the steering motor.

5. The master drive unit of claim 1, the planetary steering system includes a sun gear directly driven by the steering motor, three or more planet gears arranged around and in mesh with the sun gear, a ring gear circumferentially surrounding and in mesh with the planet gears, a slew ring bearing comprising an inner race and an outer race, and a carrier comprising three or more protrusions about which the planet gears rotate.

6. The master drive unit of claim 5, wherein the outer race is mounted to a mounting frame such that the outer race is rotationally coupled to the traction motor and the steering motor, and the inner race is rotationally fixed to a gearbox housing such that the gearbox housing and the mounting frame are rotationally separated by the slew ring bearing.

7. The master drive unit of claim 6, wherein rotation of the sun gear drives rotation of the gearbox housing via the planetary steering system such that a rotational speed of the gearbox housing is less than a rotational speed of the sun gear.

8. A master drive unit, comprising:
a traction motor adapted to rotate a wheel about a lateral axis via gears and shafts;
a steering motor adapted to rotate the wheel about a vertical axis perpendicular to the lateral axis via a planetary steering system vertically stacked with the traction motor and the steering motor in series along the vertical axis, wherein the planetary steering system rotationally couples the steering motor with a gearbox housing enclosing the gears and the shafts driven by the traction motor.

9. The master drive unit of claim 8, wherein the planetary steering system includes a sun gear directly driven by the steering motor, three or more planet gears in mesh with the sun gear, a ring gear in mesh with the planet gears, and a carrier that is rotationally independent from the ring gear.

10. The master drive unit of claim 9, wherein either the ring gear or the carrier is rotationally fixed to an inner race of a slew ring bearing and the other of the ring gear and the carrier is rotationally fixed to an outer race of the slew ring bearing.

11. The master drive unit of claim 9, wherein the carrier includes protrusions extending either upward or downward along rotational axes of the planet gears that are parallel with the vertical axis.

12. The master drive unit of claim 9, wherein either the ring gear or the carrier is rotationally stationary and the other of the ring gear or the carrier is configured to rotate slower than the sun gear.

13. The master drive unit of claim 9, wherein the planet gears are rotationally stationary with respect to the vertical axis.

14. The master drive unit of claim 10, wherein the inner race and the gearbox housing are indirectly rotationally fixed.

15. A vehicle, comprising:
one or more master drive units each positioned vertically above a wheel and including:
a traction motor adapted to rotate the wheel about a lateral axis;
a steering motor adapted to rotate the wheel about a vertical axis; and
a planetary steering system for speed reduction of the steering motor, wherein the traction motor, the steering motor, and at least some components of the planetary steering system are coaxially centered about the vertical axis;
and
a controller adapted to send a signal to drive to the traction motor to rotate the wheel about the lateral axis and to the steering motor to rotate the wheel about the vertical axis.

16. The vehicle of claim 15, wherein the steering motor is adapted to drive a sun gear and the traction motor is adapted to drive a shaft that extends through the sun gear, and wherein the sun gear and the shaft are rotationally independent.

17. The vehicle of claim 16, wherein a speed reduction ratio between rotation of the sun gear and the wheel about the vertical axis is equal to a ratio of a number of ring gear teeth to a number of sun gear teeth.

18. The vehicle of claim 16, wherein a speed reduction ratio between rotation of the sun gear and the wheel about the vertical axis is equal to one plus a ratio of a number of ring gear teeth to a number of sun gear teeth.

19. The vehicle of claim 16, wherein the sun gear comprises a ring-shaped protrusion in face sharing contact with a spacer that forms spaces directly below a bottom surface of the sun gear.

20. The vehicle of claim 15, wherein the lateral axis and the vertical axis intersect.
